(19) United States
(12) Patent Application Publication
(10) Pub. No.: US 2026/0025402 A1
(43) Pub. Date: Jan. 22, 2026

(54) METHOD AND DEVICE FOR DETERMINING SECURITY COMPLIANCE OF NETWORK INFRASTRUCTURE

(71) Applicants: University of New South Wales, Sydney (AU); Cisco Systems Australia Pty Limited, North Sydney (AU)

(72) Inventors: Arash SHAGHAGHI, Sydney (AU); Mohammad GOUDARZI, Sydney (AU); Shohreh DELDARI, Sydney (AU); Aditya JOSHI, Sydney (AU); Jesse LAEUCHLI, Sydney (AU); Sanjay Kumar JHA, Sydney (AU)

(21) Appl. No.: 19/273,532

(22) Filed: Jul. 18, 2025

(30) Foreign Application Priority Data
Jul. 18, 2024 (AU) 2024902235

(51) Int. Cl. H04L 9/40

(52) U.S. Cl. CPC H04L 63/1433; H04L 63/20

(57) ABSTRACT

Computer-implemented methods, instructions and systems for determining the compliance of a network infrastructure with a security policy. The network infrastructure includes a plurality of components. A method includes extracting, by applying a first trained machine learning model to a security standard, at least one security policy of the security standard, and obtaining, from each component of the plurality of components of the network infrastructure, contextual data defining the security configurations and security capabilities of the component. The method further includes processing the contextual data and the security policy of the security standard, by a second trained machine learning model, the second trained machine learning model configured to output an indication of whether the network infrastructure satisfies the security policy of the security standard.

### CROSS-REFERENCE TO RELATED APPLICATIONS

The present application claims priority from Australian Provisional Patent Application No 2024902235 filed on 18 Jul. 2024, the contents of which are incorporated herein by reference in their entirety.

### TECHNICAL FIELD

Aspects of the disclosure relate generally to systems and methods for security management of a network of components and, more specifically, to determining the compliance of a network infrastructure with a security policy.

### BACKGROUND

Security ranks as top priority for the majority of businesses/organizations operating in today's environment. There exists a growing requirement to effectively determine whether a network infrastructure complies with security standards, frameworks, controls, or regulations. Security standards, policies, controls, and regulations are different across various organizations. For instance, each organization may use different set of standards for security compliance checking. Even organizations using same security-related standards may only consider a subset of security policies from each specific standard. Also, each organization defines its security requirements, risks, and mitigation policies according to their own context and values. For instance, a security standard may enforce a security standard for “authentication and authorization”. One organization may only consider “strong credentials” policy to satisfy this security standard, while other organizations may enforce “strong credentials” alongside “two factor authentication” to meet this security standard. Additionally, security standards, policies, controls, and regulations may be periodically updated, which signifies the importance of regular monitoring and compliance checking to latest changes.

Internet of Things (IoT) networks may produce large quantities of data across different systems. Security compliance checking for IoT networks may involve ad-hoc and inefficient auditing and validation of deployment settings by each IoT data consumer to ensure compliance with their specific security requirements. This practice limits the reusability of IoT data and may overlook critical deployment considerations affecting the trustworthiness of the data, leading to potential security risks. The process of security compliance checking for enforced security standards of even one organization using IoT data is typically manual and time-intensive.

One of the most time-consuming parts of security compliance checking is identifying relevant security standards and policies among standards and guidelines based on the requirements of organizations. Especially in situations in which there are several security standards with which an organization desires compliancy. Moreover, security standards are updated regularly, which brings up the necessity to re-check all the policies again.

It is desired to address or ameliorate one or more shortcomings or disadvantages associated with the prior art, or to at least provide a useful alternative hereto.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY

In accordance with an aspect of the present disclosure, there is provided a computer-implemented method for determining the compliance of a network infrastructure with a security policy. The network infrastructure comprises a plurality of components. The method comprises extracting, by applying a first trained machine learning model to a security standard, at least one security policy of the security standard, and obtaining, from each component of the plurality of components of the network infrastructure, contextual data defining the security configurations and security capabilities of the component. The method further comprises processing the contextual data and the security policy of the security standard, by a second trained machine learning model, the second trained machine learning model configured to output an indication of whether the network infrastructure satisfies the security policy of the security standard.

In some embodiments, processing the contextual data and the security policy of the security standard comprises mapping, by the second trained machine learning model, the security policy to the security configurations defined by the contextual data.

In some embodiments, processing the contextual data and the security policy of the security standard comprises determining, by processing the security capabilities, whether the network infrastructure is capable of satisfying the security policy, and, in response to determining that the network infrastructure is capable of satisfying the security policy, determining, by processing the security settings, whether the network infrastructure satisfies the security policy of the security standard.

In some embodiments, obtaining the contextual data comprises issuing at least one command to at least one component of the network infrastructure, and receiving, from the at least one component of the network infrastructure, the contextual data.

In some embodiments, obtaining the contextual data comprises applying a third trained machine learning model to raw contextual data to determine standardised contextual data. In some embodiments, the standardised contextual data is formatted as a hierarchical JSON structure.

In some embodiments, the contextual data comprises one or more of: infrastructure topology; security settings; security capability; supported encryption algorithm; key length; protocol version; firmware version; communication protocol; key exchange protocol; and hash function.

In some embodiments, obtaining contextual data comprises determining an infrastructure topology of the network infrastructure. In some embodiments, determining an infrastructure topology comprises obtaining, from routers in the network infrastructure, local graph topologies and combining the local graph topologies to determine a topology graph of the network infrastructure.

In some embodiments, extracting at least one security policy of the security standard comprises segmenting the security standard into a plurality of segments. In some embodiments, extracting at least one security policy of the security standard comprises applying a trained embedding transformer model to generate a security embeddings of a segment of the plurality of segments. In some embodiments, the trained embedding transformer model is trained on security standards.

In some embodiments, the method further comprises receiving a security query from a user of the network infrastructure, and selecting, based on the security query, the at least one security policy. In some embodiments, selecting, based on the security query, the at least one security policy comprises applying a large language model to map the security query to the at least one security policy. In some embodiments, selecting, based on the security query, the at least one security policy comprises applying a trained embedding transformer model to generate a query embedding of the security query, and selecting, based on the query embedding, the at least one security policy.

In some embodiments, selecting, based on the query embedding, the at least one security policy comprises determining a semantic similarity between the query embedding and the security embedding. In some embodiments, determining a semantic similarity between the query embedding and the security embedding comprises determining a similarity threshold.

In some embodiments, the method further comprises, in response to the indication of whether the network infrastructure satisfies the security policy of the security standard indicating that the network infrastructure does not satisfy the security policy of the security standard, determining a configuration update for at least one component of the plurality of components, and providing the configuration update to the at least one component of the plurality of components.

According to another aspect of the present disclosure, there is provided a machine-readable storage medium storing instructions which, when executed by one or more processors, individually or in combination, cause the one or more processors to perform a method disclosed herein.

According to another aspect of the present disclosure, there is provided machine-readable instructions which, when executed by one or more processors, individually or in combination, cause the one or more processors to perform a method disclosed herein.

According to another aspect of the present disclosure, there is provided a system comprising one or more processors, and memory comprising computer executable instructions, which when executed by the one or more processors, individually or in combination, cause the system to perform a method disclosed herein.

### BRIEF DESCRIPTION OF THE DRAWINGS

The embodiments of the disclosure will now be described with reference to the accompanying drawings, in which:

FIG. 1 is a block diagram of system for determining an indication of compliance of a network infrastructure with a security standard, according to an embodiment;

FIG. 2 illustrates a software architecture for the security compliance checking application, in accordance with an embodiment;

FIG. 3 illustrates a network infrastructure, in accordance with an embodiment;

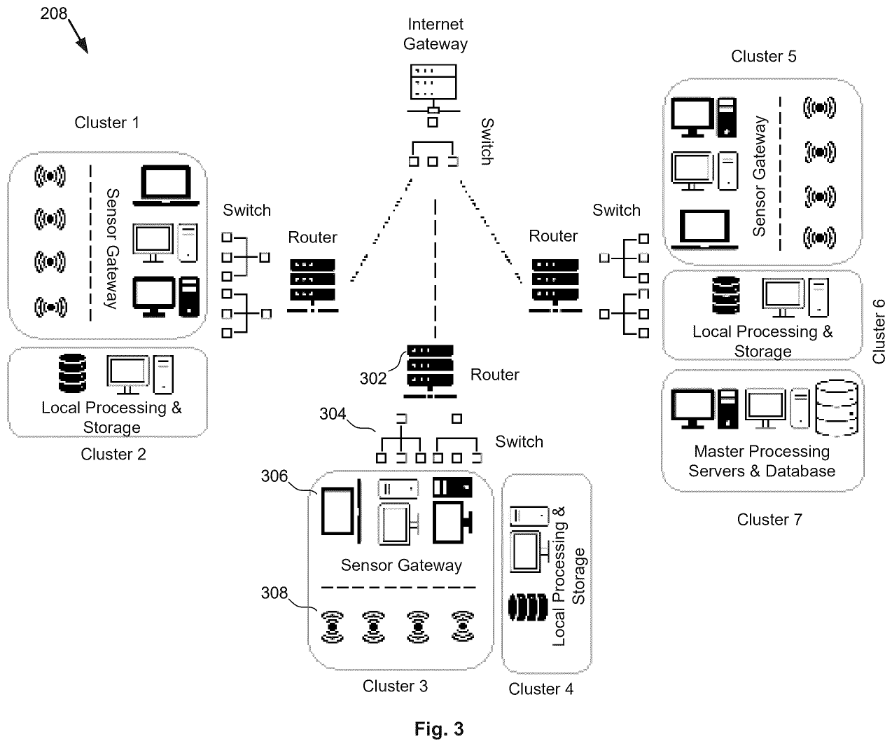

FIG. 4 illustrates submodules of the Policy Extraction module and the Query Interpreter module, in accordance with an embodiment;

FIG. 5, illustrates a process flow diagram of extracting one or more security policies, in accordance with an embodiment;

FIG. 6 illustrates a process for mapping a security policy to one or more commands to be issued to components of the network infrastructure, in accordance with an embodiment;

FIG. 7 illustrates a mapping from a plurality of relevant security policies to attributes, in accordance with an embodiment;

FIG. 8 illustrates a table listing configuration items and commands associated with the ‘Device Authentication’ attribute, for three component types of the network infrastructure, in accordance with an embodiment;

FIG. 9 illustrates processes for extracting contextual data from the components of the network infrastructure, in accordance with an embodiment;

FIG. 10 illustrates an extract of a Python script to extract contextual data from a Cisco IR829 router, in accordance with an embodiment; and

FIG. 11 illustrates a sample of raw contextual data extracted from the Cisco IR829 router, in accordance with an embodiment.

### DETAILED DESCRIPTION

Provided herein is a computer-implemented method for determining an indication of compliance of a network infrastructure with a security standard.

Embodiments of the system described herein may enable IoT data consumers to access and utilize security-related contextual data pertaining to IoT deployment and IoT data. Embodiments of the system described herein may provide one or more of: high-level and granular visibility; automated security compliance checking; automated risk assessment; and data assurance for both data consumers and service providers.

Embodiments of the system described herein may provide access to detailed technical contextual data regarding IoT deployment, encompassing infrastructure and IoT data.

Embodiments of the system described herein may automate security policy extraction from various trusted sources of security standards (such as official standard bodies e.g., ISO, IEC, NIST), and locally defined policies and regulations within each organization using machine learning (ML) techniques.

Embodiments of the system described herein may automate policy extraction from legal contracts, educational standards, environmental regulations and government policies.

Embodiments of the system described herein may automate the process of monitoring and updating latest security standards, controls, policies, regulations based on the requirements of each organization/IoT data consumer using machine-learning techniques.

Embodiments of the system described herein may define how contextual data extracted from IoT infrastructure and data are relevant to each identified security standard, policy, and regulations within an organization with a semi-automated or automated solution using ML and security expert opinion.

Embodiments of the system described herein may automate security compliance checks and risk assessment using machine learning techniques.

### System Architecture

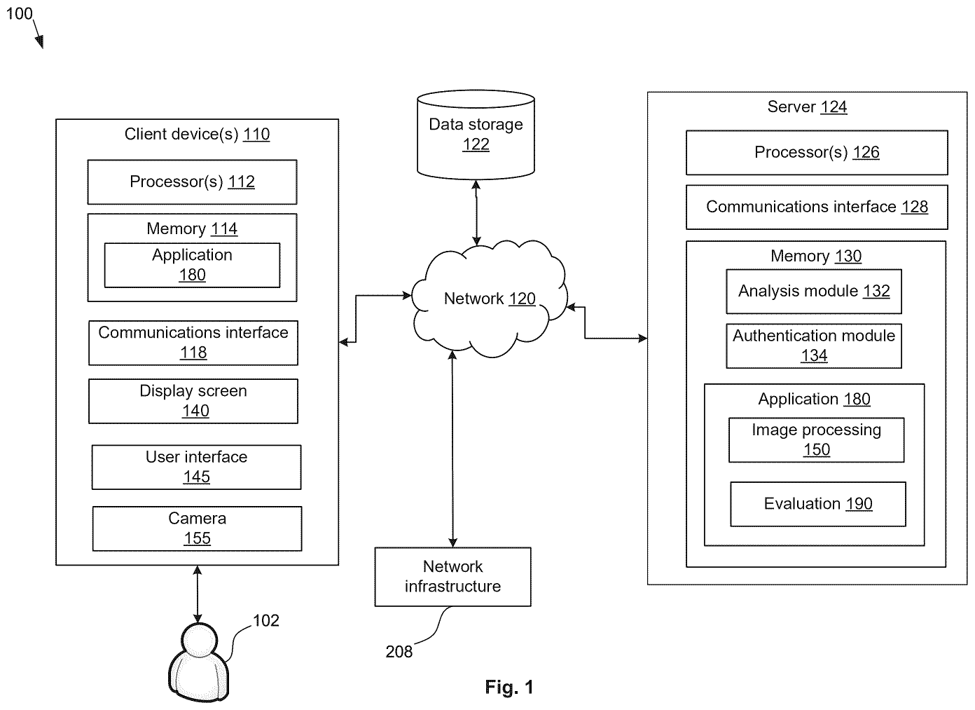

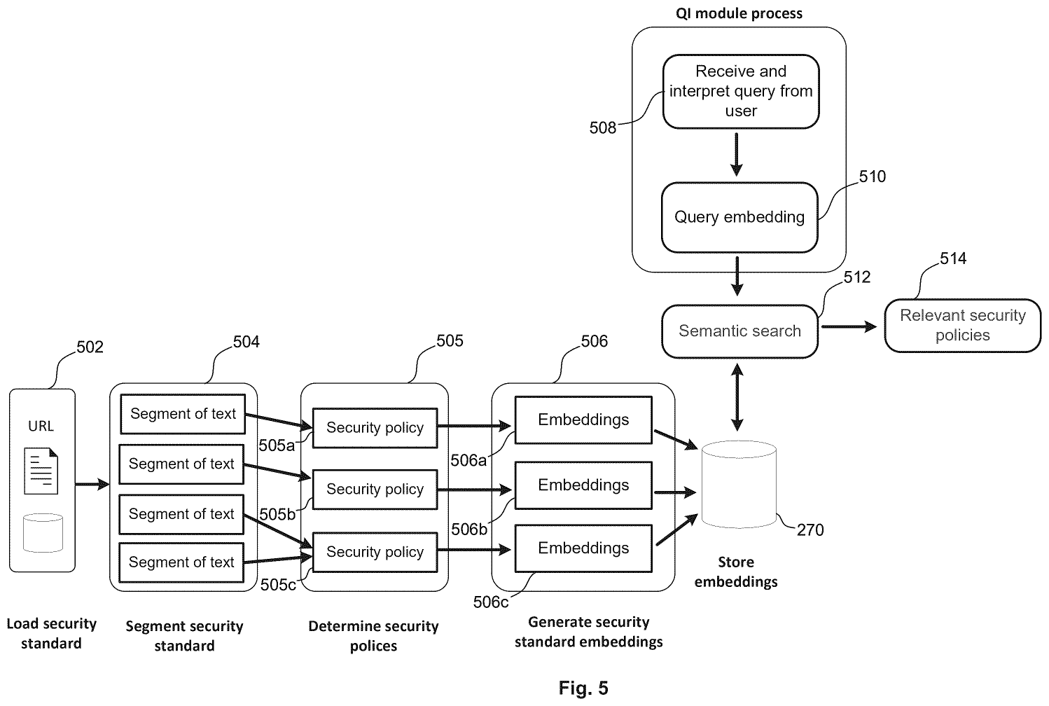

FIG. 1 is a block diagram of system 100 for determining an indication of compliance of a network infrastructure 208 with a security standard, according to an embodiment. The system 100 of FIG. 1 provides means for implementing the method illustrated in the process flow diagram of FIGS. 5, 6 and 9.

The system 100 may comprise: one or more client device(s) 110; external data storage 122; a server 124; and/or one or more third party server(s) 170 in communication over a network 120.

Client device 110 may comprise a mobile or handheld computing device such as a smartphone or tablet, a laptop, or a PC, and may, in some embodiments, comprise multiple computing devices. The client device 110 may comprise one or more processor(s) 112, memory 114 and/or communications interface 118. The processor(s) 112 may comprise one or more microprocessors, central processing units (CPUs), application specific instruction set processors (ASIPs), application specific integrated circuits (ASICs) or other processors capable of reading and executing instruction code. The processor(s) 112 may be configured to receive stored instructions (i.e. program code) from memory 114, which when executed by the one or more processors 112, individually or in combination, cause the client device 110 to function according to the described embodiments. Client device 110 comprises one or more display screens 140, each of the one or more display screens 140 being configured to display a graphical user interface (GUI) 145 in implementing a method. A display device may comprise one or more individual display screens. The functionality and content of the GUI 145 is provided by the processor(s) 112, and the memory 114, which may be cooperating with the security compliance checking application 180.

The client device 110 may be operated by a user 102. The user may control the operation of the client device via the user interface 145 and may receive output from the client device via the display screen 140.

The functionality of the system 100 may be defined by a security compliance checking application 180. In some embodiments, the application comprises a back-end and a front-end. In the embodiment illustrated in FIG. 1, the back-end of application 180 is configured to execute on the server 124, and the front-end of application 180 is configured to execute on the client device 110.

Application 180 may be executed, in part or in full, on client device 110. Application 180 may be executed, in part or in full, on server 124. Application 180 may comprise a distributed application, executing across a plurality of processing components. Machine-readable code (e.g. software) defining application 180 may be stored, in part or in full, on client device 110. Machine-readable code (e.g. software) defining application 180 may be stored, in part or in full, on server 124. Application 180 may receive inputs (e.g. user queries and security standards) from data storage 122, or from other sources internal to the server 124, internal to the client 110, or accessible over the network 120. Application 180 may store the output products (indications of compliance and compliance recommendations) in data storage 122, in memory 130, memory 114, and/or transmit the output products over network 122.

The memory 114 may comprise application 180 which comprises computer executable code, which when executed by the one or more processors 112, individually or in combination, is configured to allow client device 110 to facilitate the intuitive viewing and navigation of data displayed on a screen 140 of the client device 110. The communications interface 118 facilitates communications with components across the network 120, such as: data storage 122, server 124, and/or a network infrastructure under test 208. The communications interface 118 may comprise a combination of network interface hardware and network interface software suitable for establishing, maintaining and facilitating communication over a relevant communication channel.

The network 120 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 120 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, some combination thereof, or so forth.

The data storage 122 may form part of or be local to the system 100, or may be remote from and accessible to the system 100, for example, via the communications network 120. The data storage 122 may be configured to store data associated with the system 100. The data storage 122 may be a centralised data storage.

In some embodiments, the server 124 may comprise one or more processors 126 and memory 130 storing instructions (e.g. program code) which when executed by the processor(s) 126, individually or in combination, causes the system 100 to function according to the described methods. The processor(s) 126 may comprise one or more microprocessors, central processing units (CPUs), application specific instruction set processors (ASIPs), application specific integrated circuits (ASICs) or other processors capable of reading and executing instruction code.

The memory 130 may comprise one or more volatile or non-volatile memory types. For example, memory 130 may comprise one or more of random access memory (RAM), read-only memory (ROM), electrically erasable programmable read-only memory (EEPROM) or flash memory. Memory 130 is configured to store program code accessible by the processor(s) 126.

### Network Infrastructure

A network infrastructure refers, broadly, to the hardware and software resources of a network that enable network connectivity, communication and operations between users, devices, application, and the internet.

A network infrastructure 208 comprises a plurality of components communicatively connected via one or more communication mediums. A network infrastructure may comprise a plurality of heterogeneous components. Each component may be configured to communicate with one or more other component of the infrastructure. A component of the network infrastructure may comprise: a physical device; a virtual device, or software executing on one or more physical and/or virtual devices; or any combination thereof. A component of the network infrastructure may comprise: a router; a switch; a server; a personal computer; a sensor; or another digital component.

A network infrastructure may comprise an Internet of Things (IoT). An IoT may comprise a network of devices (e.g., computers, vehicles, home appliances, and other items) embedded with electronics, software, sensors, actuators, and connectivity which enables these devices to connect and exchange data. Some or all of the devices may be configured to collect and share data. The devices of the IoT may be remotely monitored and controlled by other devices external to the IoT.

An IoT may be applied in a smart home equipped with connected appliances and sensors. An IoT may be applied in a large-scale industrial systems such as smart cities or smart factories. The interconnection of the IoT devices may facilitate automation and data collection.

An IoT may be comprised of a plurality of heterogeneous devices, wherein the devices may differ in terms of capability, functionality, configurability and configuration status.

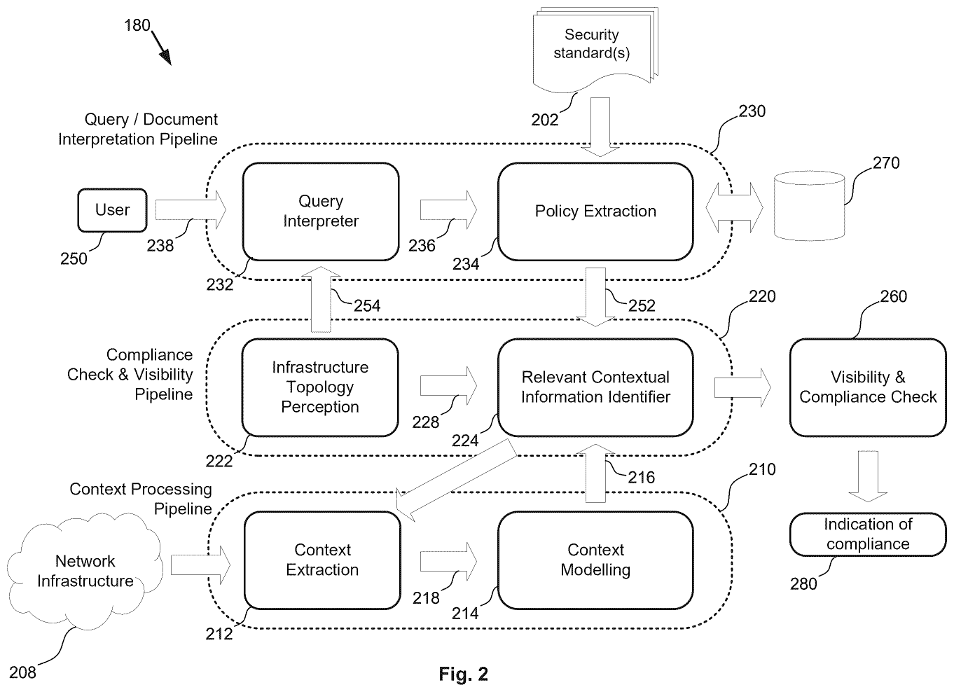

FIG. 2 illustrates a network infrastructure 208, in accordance with an embodiment. The network infrastructure comprises a plurality of clusters of components. In one cluster, the network infrastructure comprises: a Cisco IR820 router 302; a switch 304; a plurality of personal computers (PCs) and a plurality of sensors 306.

### Security Compliance Checking

Security compliance checking for the network infrastructure may comprise determining whether the components of the network infrastructure adhere to established security standards and regulations. This process is crucial because IoT devices often handle sensitive data and can be vulnerable to various cyber threats. Compliance checking may include verifying that devices are using secure communication protocols, have up-to-date firmware and software, and are configured correctly to minimize potential security risks. It also involves assessing the data privacy measures in place, such as data encryption and secure storage. Regular audits and penetration testing can be part of compliance checking to identify and address potential security vulnerabilities. Ultimately, the goal of security compliance checking in IoT is to create a secure environment that protects data integrity, confidentiality, and availability while ensuring the devices function as intended.

In many circumstances, it is desirable to ensure that the IoT complies with a desired level of security. Accordingly, it is desirable to verify that the IoT, collectively, and the individual devices within the IoT, comply with a set of desired security policies.

The application 180 is configured to determine whether the network infrastructure, in use, is compliant with a security policy.

### Security Standards

A security standard comprises a safeguard or countermeasure used to avoid, detect, counteract or minimise security risks to the networked infrastructure 208. A security standard may comprise a requirement defined by a party responsible for implementing, managing or monitoring the networked infrastructure 208. A security standard may define security functionalities that are considered compulsory, recommended or option.

A security standard may comprise security guidelines, security principles, organisation-defined security policies, implementation-specific security policies, or manufacturers recommendations. A security standard may pertain to one or more security principles, such as, but not limited to: data security; user authentication; encryption; cybersecurity; and access restrictions.

In some embodiments, a security standard comprises a published security standard document (e.g., an information security standard, or a cyber security standard). A security standard may be published by an official body, such as the International Organization for Standardization (ISO) or the National Institute of Standards and Technology (NIST). Examples of security standards issued by official bodies include: NIST 800-53; International Electrotechnical Commission (IEC) 62443; ISO 27002; NIST 88-53; and ISO 27002.

A security standard may comprise a series of documented processes that define how to implement, manage, and monitor various security functions of a component or set of components. Adherence to a security standard may mitigate security risks and reduce security vulnerabilities. Adherence to a security standard may be a requirement for achieving regulatory compliance.

### Security Policy

A security policy comprises a determinable capability or configuration of one or more components of the network infrastructure. A security policy may be expressed in natural language, a standardised encoding (such as a JSON format); a vector embedding; or other format. A security policy may be expressed as a: requirement; demand; precondition; condition; provision; obligation; or desirable. A security policy may comprise a direct text extract from a security standard, without alteration. Alternatively, a security policy may comprise a summary, combination or interpretation of one or more text extracts from a security standard.

### Approaches to Security Policy Extraction

Security policies may be extracted, manually, from the security standards by a domain expert. Manual extraction of security policies may require meticulous reading, indexing and cross-referencing of security standard documents. Additionally, due to the evolving nature of the security landscape, the task of extracting security policies may involve continuous monitoring and adaptation to new standards. Accordingly, manual extraction of security policies from security standard documents is not scalable to cover numerous standards and cannot easily adapt to ever-growing changes and new regulations.

Provided herein is a computer-implemented method for extracting security policies from one or more security standard documents.

### FIG. 2—Software Architecture

FIG. 2 illustrates a software architecture for the security compliance checking application 180, in accordance with an embodiment.

The application 180 comprises three pipelines, namely: a Query and Document Interpretation Pipeline (hereafter, the QDI pipeline) 202; a Context Processing Pipeline (hereafter, the CP pipeline) 204; and a Compliance Check and Visibility Pipeline (hereafter, the CCV pipeline) 206.

In some embodiments, the functionality of the application may be distributed across different pipelines and modules without changing the functionality of the system. For example, the functionality described herein as being performed by a particular module or pipeline may, in another embodiment, be performed by a different module or pipeline, or a combination of modules or combination or pipelines, without changing the functionality described herein.

### QDI Pipeline

The application 180 comprises a Query and Documentation Interpretation (QDI) pipeline 230. The QDI pipeline has two main roles. Firstly, the QDI pipeline is configured to extract security policies from one or more security standards 202, and store these extracted security policies in a storage medium 270.

Secondly, in response to receiving a user query, the QDI pipeline is configured to determine one or more security policies that are relevant to the user query. These security policies are referred to as relevant security policies 252. The application 180 is configured to determine whether the infrastructure 208 is compliant with these one or more relevant security policies.

### Policy Extraction Module

The QDI pipeline 230 comprises a Policy Extraction (PE) module 234. The PE module is configured to extract, from a security standard 202, one or more security policies. In some embodiments, the PE module is configured to extract, from a security standard, one or more security policies that relate to a query 238 provided by a user 250.

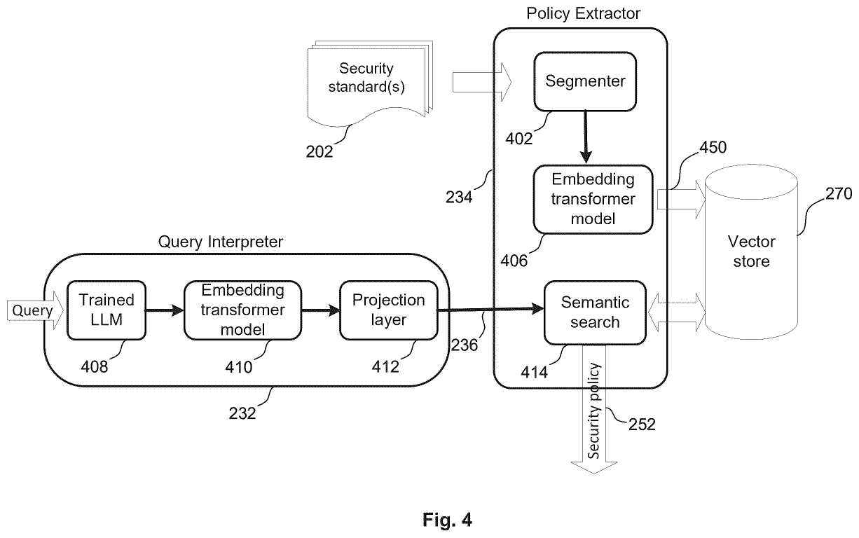

FIG. 4 illustrates submodules of the PE module and the QI module, in accordance with an embodiment. FIG. 5, illustrates a process flow diagram of extracting one or more security policies, as performed by the PE module and the QI module, in accordance with an embodiment.

### Loading the Security Standard

In operation 502, the PE module loads the one or more security standards. A security standard may comprise: a webpage addressable via a Universal Resource Locator (URL); a digital document, such as a PDF document; a scan of a physical document; data stored in a database; or any other digital information format.

The PE module may be configured to preprocess the loaded security standard to aid in interpretation of the security standard by the PE module. Preprocessing may comprise parsing the security standard or applying optical character recognition (OCR). Preprocessing may comprise splitting the contents of the standard document into sections and subsections. Preprocessing may comprise discarding content of the standard document that does not comprise security policy information, such as background information or tables of contents.

In some embodiments, the PE module applies regular expressions to identify and extract various components, including section and subsection titles, headers and footers, body text, images, and more. In some embodiments, the PE module is configured to convert the standard document into a markup language, such as Markdown, which is a lightweight markup language that may be used for formatting plain text. Markdown uses a simple syntax with special characters to indicate formatting elements. The Markdown content maintains a structured and readable form for the security standard.

### Segmentation

The PE module is configured to segment a security standard 202 into smaller chunks of information, embedding the chunks of information in vector format using a pre-trained embedding model, and then storing the vectors in efficiently storage, such as a vector store.

In operation 504, the segmenter submodule 402 of the PE module segments the security standard into segments of information. The segments of information may comprise segments of text.

In some embodiments, the PE module is configured to apply a trained machine learning model, such as a large language model, to extract the one or more segments of information from the security standard. In some embodiments, the large language model is configured to apply retrieval augmented generation to extract the one or more segments of information from the security standard.

In some embodiments, Markdown features are used to retain the structure of the security standard. In some embodiments, the PE module segments the text of the security standard into smaller segments blocks, wherein each segment corresponds to a subsection of the original document. To preserve the structural information of the text, references to the sections and subsections of the corresponding text may be stored as metadata in association with the segments of text.

Considering, for example, the security standard comprises a structured document, as is often the case for security standards that are issued by official bodies. The length of subsections of the security standard may vary from a couple of lines to a couple of pages. This lack of consistency in the amount of information in each subsection can cause problems such as not fitting to the context size of the language models and embedding tools applied by the PE module, or degrading the performance of embedding models. Hence, in some embodiments, it is desirable to segment documents into smaller chunks and enforce a cap size on the length of blocks of Documents. LangChain has a number of built-in document transformers that facilitate segmenting the text.

Preferably, semantically related pieces of text are kept together in a segment. Additionally, it is preferable that each segment of text comprises semantically meaningful information on its own without depending on prior or subsequent segments.

In some embodiments, the segmenter 402 is configured to divide the security standard into segments based on the structural division of the document (i.e., by sections). Advantageously, this segmentation approach is likely to provide segments which comprise content that is semantically related and coherent. In some embodiments, the segmenter comprises: a recursive splitter; a HTML-based splitter; a character-based splitter; or a combination thereof.

In some embodiments, a character-based splitter may segment the text into separate chunks in the middle of sentences. However, with the recursive splitter, the chunk boundaries are predominantly positioned at the end of paragraphs or sentences.

### Security Policies

In operation 505, the PE module 234 is configured to determine one or more security policies (505a, 505b and 505c) based on the extracted segments of text determined in operation 504. In some embodiments, a security policy may comprise a segment of text. In some embodiments, the PE module may determine a security policy by combining two or more segments of texts (in full or in part). The two or more segments of text may be semantically similar, or represent duplicated information. In some embodiments, the PE module may determine two or more security policy by further segmenting a segment of text.

### Security Embeddings

A method to store and search over unstructured information (such as text) is to embed the information as a numerical vector (e.g., an embedding) and store the resulting embedding in a vector store. Then, at query time an unstructured query (e.g., a natural language query) can be embedded as a numerical vector. To determine an answer to the query, the security embedding vectors corresponding to the security policies may be searched to determine one or more security embeddings that are most similar, numerically, to the embedded query.

The PE module 234 further comprises a trained machine learning model 406 configured to generate embeddings (e.g., security embeddings) of security policies. In some embodiments, the trained machine learning model comprises a trained embedding transformer model. The trained machine learning model may be referred to as a first trained machine learning model

Embeddings comprise vector representations of text, enabling the text to be analysed within a vector space. Embeddings facilitate tasks such as semantic search, where text pieces with similar meanings are identified in the vector space. Embeddings allow the PE module to organise and categorise a text based on the text's semantic meaning. To generate the embeddings, An embedding describes a segment of text in terms of a vector (coordinate) representation.

A vector is a mathematical concept representing both magnitude and direction. In the realm of natural language processing, vectors that are close to each other represent pieces of information that have a similar meaning to each other. Therefore, proximity in the vector space indicates similarity in textual space.

In operation 506, the PE module is configured to apply a first trained machine learning model to the security standard to extract at least one security policy of the security standard.

In some embodiments, in operation 506, the PE module applies the trained embedding transformer model to the text segments (extracted in operation 504). The trained embedding transformer model outputs one or more security embeddings (e.g., 506a, 506b and 506c) that represent the characteristics and semantic meaning of each segment of text.

Each of the security embeddings (e.g., 506a, 506b and 506c) represents a security policy.

In some embodiments, the embedding transformer model 406 has been trained on cybersecurity-related text. In some embodiments, the embedding transformer model is trained by applying data augmentation, which comprises modifying training data to create more diverse examples. In some embodiments, the embedding transformer model is trained by applying adversarial training, which comprises training on examples specifically designed to be challenging for the model. Data augmentation and adversarial training can help improve the model's robustness and its ability to understand domain-specific nuances.

In some embodiments, the embedding transformer model 406 is trained by applying a masking technique to a dataset of security standard texts. The masking technique may comprise extracting a list of sentences from security standard documents, such as IEC 62433, NIST, ISO 27001 (2005), and ISO 27002 (2013). For each sentence, a random selection of words and/or phrases are masked, and then the embedding transformer model is trained to accurately predict the masked words or phrases.

### Storing the Embeddings

The PE module is configured to store the security standard embeddings 450 in a storage medium 270. In some embodiments, the storage medium 270 comprises a vector store, specialised to store embedding vectors. Storage medium 270 may comprise a non-transitory storage medium.

The PE module stores each embedding vector, determined in operation 506, in a vector store 270, along with the segment of text that corresponds to the embedding vector. The vector store is configured to store the embedding vectors and to facilitate vector searches on the stored embedding vectors. In some embodiments, the vector store may comprise a Chroma vector warehouse and embedding database.

### Query Interpreter

The QDI pipeline comprises a Query Interpreter (QI) module 232. In operation 508, the QI module is configured to receive, from a user, a query regarding the compliance of the infrastructure 208 with a security policy. The user may comprise a human user or any software/hardware components that may interact with the query interpreter module 232.

Further, in operation 508, the QI module interprets the received query to determine key information from the user query 250. The QI module comprises a trained large language model (LLM) 408 to extract key information from the user query.

Key information may comprise: the policy or security rule referenced in the query; the security standard(s) that the query pertains to; the network deployment, service, component or device that is the subject of the query; any additional keywords that cannot be categorised under the aforementioned fields.

In some embodiments, the query 238 is provided in a hard coded format (e.g. a hard query) or free style writing format through talking to a chat bot (e.g. soft query). In the case of hard queries, users are limited to selecting from a predefined set of standards, policies, services, deployment divisions, and other options. In soft query, the chatbot interaction format allows users to formulate questions or requests in natural language. However, in addition to interpreting the user query in this case, the natural language input may require post-processing to extract the core intent and entities from the user's message accurately. This involves employing natural language processing (NLP) techniques to parse the user's input, identify key elements, and discern the user's underlying needs. Additionally, the chatbot may engage in further communication with the user to refine and clarify the initial question, ensuring a comprehensive understanding of the user's query.

In some embodiments, the QI module formats the key information of the query into a standardised form. In some embodiments, the standardised form comprises a JSON structure.

In an example, a user provides the following query: “Does Deployment of X meet Segmentation policies based on IEC-62443 standard?”. Using the LLM model, the QI module extracts the key words of the user's query and provides the query to the embedding transformer model 410 in the following JSON structure:
Service name: X
Standard: IEC 62443
Policy: Segmentation

### Query Embeddings

In operation 510, the QI module applies an embedding transformer model 410 to determine a embedding vector (e.g., a query embedding) associated with the query 236. In some embodiments, the embedding transformer model 410 is configured to determine the query embedding based on the key information extracted from the query.

### Projection Layer

In operation 512, the semantic search module 414 identifies the one or more security standard embeddings that are most similar to the query embedding. Accordingly, it is desirable that the query embeddings and security standard embeddings are comparable in the embedding space. A challenge to comparisons in the embedding space is the disparity in length and the amount of context between the query and the segments of text from the security standards. This is often due to queries being much shorter than their corresponding answers (wherein the answers comprise one or more segments of text from security standards).

In some embodiments, to ameliorate issues arising from differences in the lengths between the queries and segments of text that comprise (at least a partial) answer to the query, the QI module comprises a projection layer 412 positioned after the query embedding transformer model 410.

### Semantic Search

In operation 512, the semantic search module is configured to determine, based the query embedding 510, which of the extracted security policies are relevant to the query 236.

In operation 512, the semantic search module 414 performs a semantic search of the security embeddings stored in the vector storage 516, to identify and retrieve security embeddings that are semantically similar to the query embedding.

Each security embedding corresponds to a security policy. Accordingly, the semantic search determines the one or more security policies that are most semantically similar to the query. These one or more security policies are considered to be relevant security policies.

In operation 514, the PE module then compiles a list of the one or more security policies identified as being most semantically similar to the query. These one or more security policies may be referred to as ‘relevant security policies’. In some embodiments, the PE module also compiles, for each relevant security policy, a corresponding reference from the security standard from which the security policy was extracted.

### Similarity Threshold

The semantic search module 414 identifies security embeddings that are semantically similar to the query embedding in accordance with a similarity threshold. In some embodiments, the similarity threshold is based on cosine similarity between embeddings. The similarity threshold defines how strict the semantic search module is in considering two embeddings (each representing different chunks of text) to be similar.

In some embodiments, the cosine distance is determines in accordance with the following equation:

Cosine distance(a,b)=1−Cosine similarity(a,b)

A lower distance (higher similarity) threshold means lower tolerance on distance and that only very similar chunks of text are considered a match, while a higher threshold would consider a broader range of distances and hence less similar items as matches as well.

### CP Pipeline

The application 180 further comprises a CP pipeline 210. The CP pipeline is configured to issue commands to the components of the network infrastructure in order to receive contextual data from the components. The CP pipeline is further configured to provide this contextual data in a standardized format to enable other system components to make use of the information.

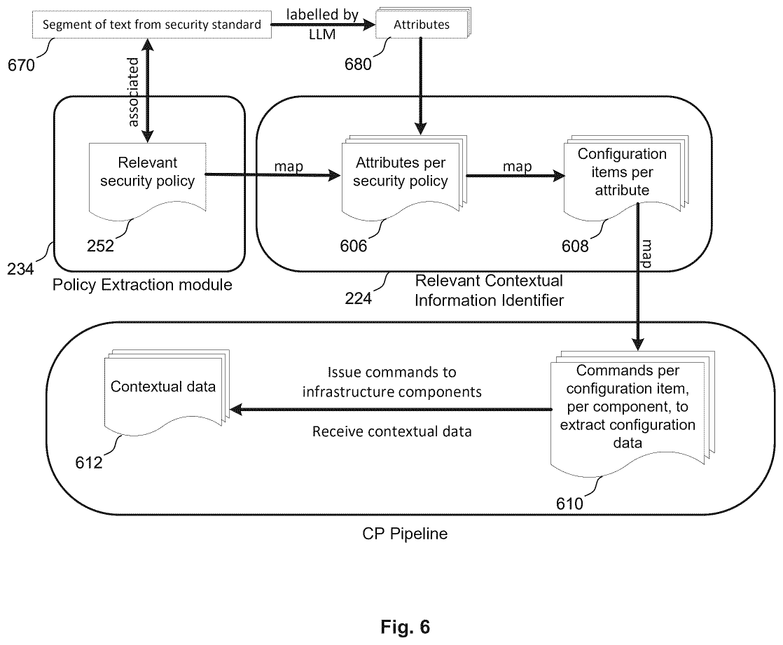

The CP pipeline comprises a context extraction module 212 and a context modelling module 214. FIG. 6 illustrates a process for mapping a security policy to one or more commands to be issued to components of the network infrastructure 208 by the context extraction module 212, in accordance with an embodiment.

### Security Capabilities and Security Settings

In relation to a security policy, a component of the network infrastructure has a security capability if the component of the network infrastructure is capable of complying with the security policy. For example, if the security policy specifies that transport layer communication must be encrypted using a 256-bit encryption key, the component has this security capability if it comprises the necessary hardware and/or software to be able to encrypt transport layer communication using a 256-bit encryption key.

In relation to a security policy, a security setting of a component of the network infrastructure indicates whether the component is configured to satisfy the security policy.

For example, if the security policy specifies that transport layer communication must be encrypted using a 256-bit encryption key, the security setting of the component will set whether the component is configured to encrypt transport layer communication using a 256-bit encryption key.

The security capabilities and security settings of a component may be determined by determining the configuration items of the component.

### Contextual Data

Contextual data comprises the security capabilities and security configurations of one or more of the components of the network infrastructure. A security configuration comprises a configuration item, as well as a value of the configuration item. Contextual data may comprise security configurations regarding the communication channels utilised by the components to communicate within the network.

In some embodiments, configuration items include, but are not limited to: encryption algorithm; authentication algorithm; key exchange protocol; key length; raw data sensitivity; firmware version; protocol versions; message communication protocol; transport layer security; hash function; digital signature; checksum; message authentication code; system logs; timestamps; or any combination thereof.

The contextual data that is obtained from the network infrastructure may extensive and varied. It may be desirable to refine and filter the contextual data.

### Configuration Items

The functionality of components within the infrastructure 208 may be configured by setting the value of one or more configuration items of the component. The value of each of the configuration items determines the security functionality that the component exhibits while in operation.

A configuration item may enable or disable a security functionality of the component. A configuration item may define which security option, of a selection of multiple security options, the component is configured to apply in operation. For example, a configuration item may comprise a selection of an encryption protocol; a selection of an encryption key size; a switch enabling or disabling transport layer authentication.

A configuration item is associated with a value, wherein the value indicates the current setting of the configuration item. For example, a configuration item defining the encryption key size applied by the component may be associated with the value ‘256 bits’. In another example, a configuration item defining the use of IP security protocols may be associated with the value ‘disabled’.

Configuration items may include, but are not limited to: encryption algorithm; key exchange protocol; encryption key length; raw data sensitivity; firmware version; protocol version; message communication protocol; transport layer security; hash function; digital signature protocol; checksum protocol; message authentication code; system logs; timestamps; static IP address; VLAN assignment; MAC address; or any combination thereof.

The components within the network infrastructure may be heterogeneous, meaning that they may differ in terms of capabilities and configuration items. The configuration items associated with a component may depend on the capabilities of the component.

### Security Attributes

In some embodiments, to map security policies to configuration items, it is advantageous to firstly determine and categorise the intent of each security policy, and to map each security policy 252 to one or more security attributes 606 from a set of pre-defined security attributes. A security attribute provides a categorisation for the security policy, based on the intent or purpose of the security policy.

An example set of security attributes comprises: software security controls; network security controls; wireless authentication; component verification; device authentication; network segmentation; encryption; user authentication; process authentication; and access control list (ACL).

Each security attribute relates to one or more configuration items of a component, wherein the configuration items determine the functionality of the component in relation to that security attribute.

The set of security attributes may be selected with the objective of minimizing overlap in terms of security intent and corresponding configuration items. In some embodiments, the mapping from security policies to security attributes may be performed manually, e.g. by a security expert, with consideration of the meaning and intent of the security policy. In some embodiments, mapping from security policies to security attributes may be performed by a machine learning techniques (such a trained neural network, a deep learning network or random forest classifier).

In some embodiments, the relevant security policies 252 may be mapped directly to the configuration items 608, skipping the step of mapping the security policies to security attributes 606.

### Attribute Mapping

The RCII module is configured to map each relevant security policy to one or more security attributes. In one embodiment, the application 180 applies a trained machine learning model to map segments 670 of the security standard to one or more security attributes 680.

In one embodiment, mapping each relevant security policy to one or more security attributes comprises determining the labels associated with the segment of text associated with the relevant security policy. In some embodiments, a large language model (LLM) was used to tag segments of the security standard with labels corresponding to one or more security attribute tags 680.

Security attribute tags may included, but are not limited to: access control; user authentication; device authentication; process authentication; wireless authentication; encryption; network security controls; software security controls; component verification; and network segmentation.

In one embodiment, a framework was used to facilitate the creation of the application 180 using large language models. In one embodiment, the framework comprises LangChain. LangChain's capabilities were combined with a tagging chain to prompt the LLM to classify given paragraphs of the security standard according to one or more security attributes as specified in a prompt. This approach leveraged the power of LLMs to understand complex text and make classifications based on the nuanced requirements of the security policies. By feeding the LLM with detailed prompts, highly relevant insights about the compliance status of various network configurations may be extracted.

In some embodiments, sentence-based prompts to the LLM were used to label the segments of text with the security attributes. Sentence-based prompts examined each sentence within the given paragraph separately and then create a unique list of relevant attributes for the whole paragraph. In some embodiments, paragraph-based prompts to the LLM were used to label the segments of text with the security attributes. Paragraph-based prompts investigated each paragraph in a single question.

### Attribute Mapping Example

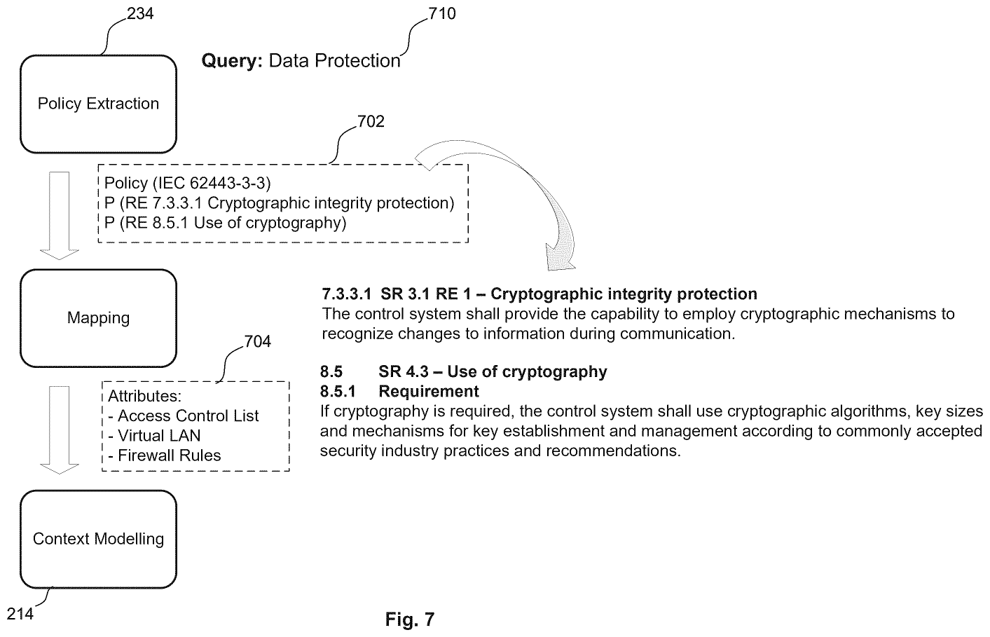

FIG. 7 illustrates a mapping from a plurality of relevant security policies to attributes, in accordance with an embodiment.

The PE module extracts a set of security policies from the IEC/ISO 62443 security standard, as described in relation to operations 504, 505 and 506. In response to receiving a user query 710, the semantic search module 414 of the PE module selects the security policies 702 as being relevant security policies. The relevant security policies were extracted from the following content of the ISO/IEC 62443 security standard.
“The control system shall provide the capability to employ cryptographic mechanisms to recognize changes to information during communication.”
“If cryptography is required, the control system shall use cryptographic algorithms, key sizes and mechanisms for key establishment and management according to commonly accepted security industry practices and recommendations.”

The PE module provides this relevant security policy 252 to the Relevant Contextual Information Identifier (RCII) module 224. The RCII module is configured to map each relevant security policy to one or more security attributes.

In one embodiment, mapping each relevant security policy to one or more security attributes comprises determining the attribute tags 680 associated with the segment of text associated with the relevant security policy.

In accordance with the example illustrated in FIG. 7, the RCII module maps the relevant security policies 702 to the security attributes ‘Access Control List, ‘Virtual LAN’, and ‘Firewall Rules’.

### Mapping to Configuration Items

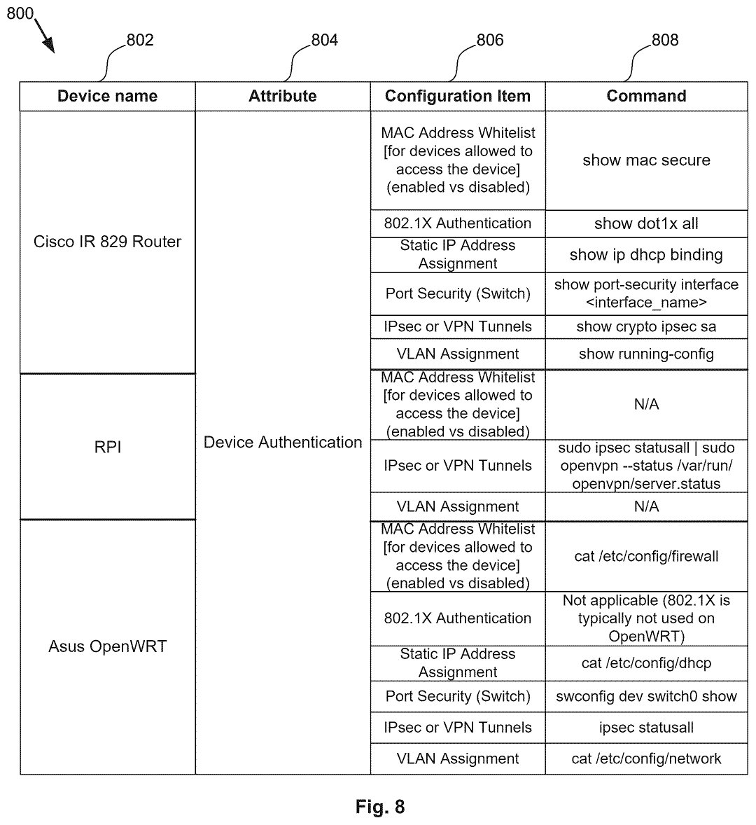

For each security attribute, the RCII module maps the security attribute to one or more configuration items 608 per component. In some embodiments, the RCII module applies a lookup table, as illustrated in FIG. 8, to map the security attribute to one or more configuration items per component

In this example, the infrastructure is heterogeneous and contains different types of devices, including Cisco IR829 router, RPi, and Asus OpenWRT router. For each device type, the RCII module determines the relevant commands 610 to extract the required contextual data 612 associated with the configuration items 608.

### Mapping Configuration Items to Commands

FIG. 8 illustrates a table 800 listing configuration items and commands associated with the ‘Device Authentication’ attribute, for three component types of the network infrastructure 208, in accordance with an embodiment. Column 802 lists three component types, including a Cisco IR 829 Router, a Raspberry Pi (RPI), and an Asus OpenWRT.

Column 804 indicates the attribute for which the configuration items in column 806 comprise relevant contextual data. In embodiments in which the security policies are mapped directly to the configuration items, column 804 may comprise the security policy for which the configuration items in column 806 comprise relevant contextual data.

Column 806 comprises a list of configuration items, per component type, wherein the configuration items and their associated values comprise relevant contextual data for the ‘Device Authentication’ attribute. Column 808 comprises commands that may be issued to the components to determine the values of the configuration items in column 806.

### Context Extraction Module

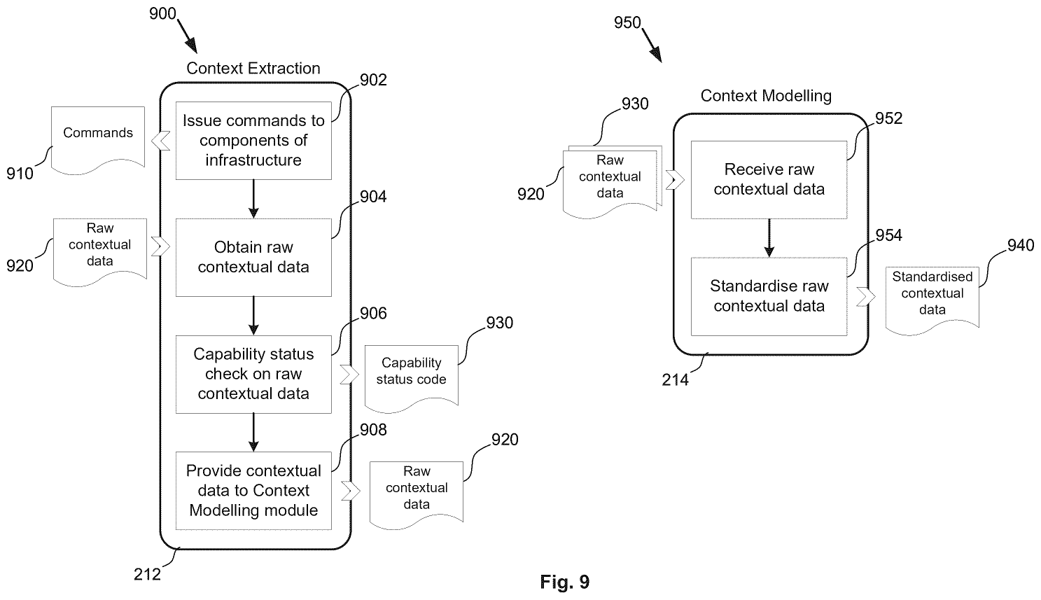

FIG. 9 illustrates processes 900 and 950 for extracting contextual data from the components of the network infrastructure, in accordance with an embodiment. Process 900 may be performed by the context extraction module 212 and process 950 may be performed by the context modelling module 214.

The RCII module is configured to provide the commands 610 (e.g. commands per configuration item, per component) to the context extraction module 212.

The context extraction module is configured to issue 902 the commands 910 to the components of the network infrastructure to extract the relevant contextual data from the components of the infrastructure. The context extraction module interacts with components and communication medium to obtain contextual data 904 from the components of the infrastructure (i.e., routers, sensors) and forwards this contextual data to the context modelling module 214.

The process of context extraction depends on the underlying infrastructure setup; in other words, sensors, devices, and servers that are deployed in the infrastructure, and the communication technology between these components.

The context extraction module 212 is configured to extract relevant contextual data from the infrastructure 208. The context extraction module issues commands to the components of the infrastructure 208 to obtain contextual data from the components of the infrastructure. The context extraction module provides 908 the contextual data to the context modelling component 214.

Contextual data comprises configuration data obtained from components of the network infrastructure 208. Contextual data comprises configuration items and the values of the configuration items for each of the components of the network infrastructure. Contextual data may further comprise capability information for the components of the network infrastructure. Contextual data may further comprise topology information of the network infrastructure.

The methods via which the context extraction module extracts contextual data from the components of the network infrastructure extraction may depend on the underlying infrastructure setup; in other words, the arrangement of sensors, devices, servers and other components that are deployed in the infrastructure, and the communication technology among these entities.

### Extracting Contextual Data

To extract contextual data from a component of the infrastructure, the contextual data module executes scripts to establish a connection to an application programming interface (API) the component. The API may comprise a web interface, or a Secure Shell (SSH) interface. In some embodiments, the scripts comprise Python scripts.

The scripts are configured to issue commands to the components to extract configuration data that satisfy the requirements of each attribute, as exemplified in Table 800.

### Example—Cisco Router IR829

The Cisco IR829 Industrial Integrated Services Routers (IR829) offers versatile connectivity options, including multimode 4G LTE and 3G wireless WAN (with dual active LTE and single LTE models), IEEE 802.11a/b/g/n WLAN, Ethernet (RJ45 and SFP), serial connections, integrated storage, and computing capabilities for hosting edge applications. Additionally, they support integrated 9-32 VDC power input. The IR829 also expands its connectivity capabilities by incorporating Low Power Wide-Area (LPWA) access through the Cisco Interface Module for LoRaWAN™. This enables the rapid deployment of a wide range of Internet of Things (IoT) solutions, such as fleet management, mass transit systems, and remote asset monitoring.

After configuring, the Cisco IR829 router can be accessed via interfaces including: SSH API, web-interfaces, and Cisco IoT Operation Dashboard. The context extraction module can extract the contextual data via one of these interfaces.

Provided herein is an example of the process, code, and resulting outputs pertaining to the extraction of contextual data from a Cisco IR829, in accordance with an embodiment.

The context extraction module 212 establishes a connection to the local web API of a Cisco IR829 router in order to retrieve its IP address for subsequent access. A Python script, executed by the context extraction module interfaces with the router and retrieves the necessary security-related contextual data. It's worth noting that while the Cisco IR829 router boasts a wealth of contextual data, not all of the contextual data is pertinent to security compliance checks.

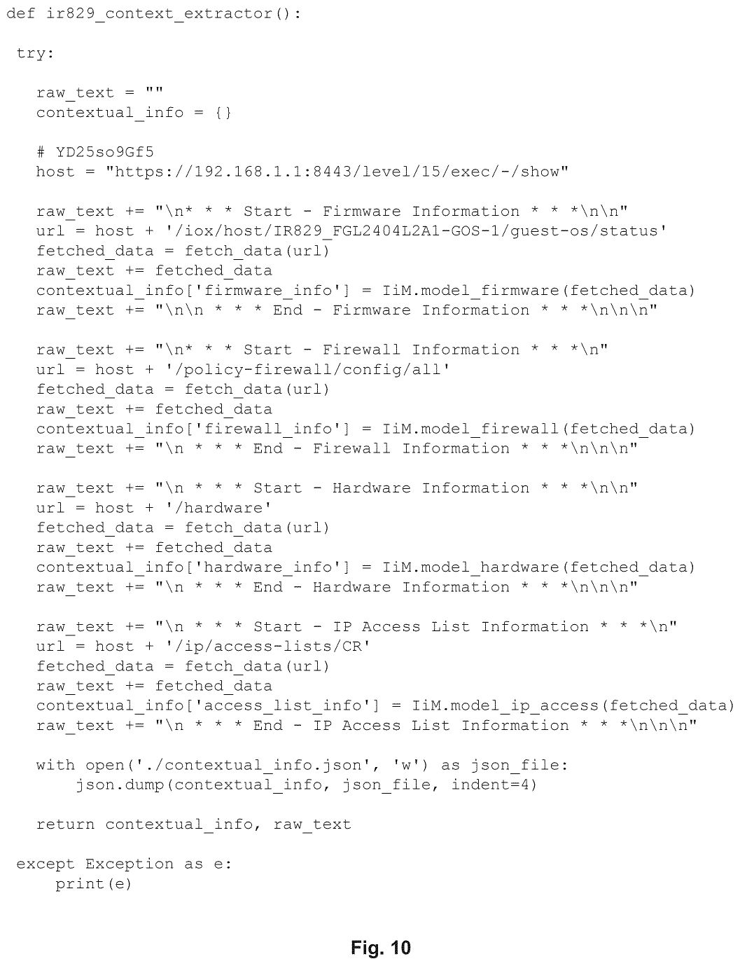

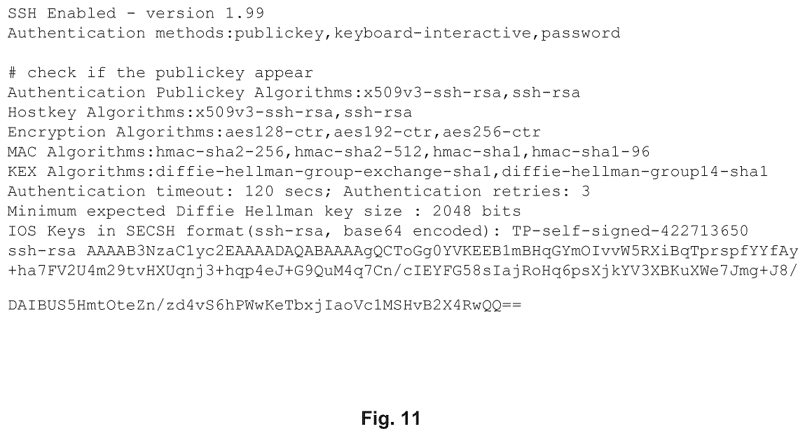

FIG. 10 illustrates an extract of a Python script executed by the context extraction module 212 to extract contextual data from a Cisco IR829 router, in accordance with an embodiment. FIG. 11 illustrates a sample of raw contextual data extracted from the Cisco IR829 router, through the execution of a Python script (an extract of which is illustrated in FIG. 10), in accordance with an embodiment.

### Capability Status Check

In operation 906, the context extraction module 212 is configured to perform a capability status check. The capability status check verifies the completeness of the raw contextual data.

In one embodiment, the output of the capability status check comprises one of three status codes to delineate the execution status of each command of the set of commands 910.
Code 2: Signifies successful execution of the command with a valid output generated, indicating the command possesses the capability associated with the command.
Code 3: Indicates successful execution of the command but with no output generated, suggesting the component possesses the capability associated with the command, but the capability remains unconfigured.
Code 4: Occurs when the command execution yields an error, indicating the component lacks the capability associated with the command by default.

### Context Modelling

Considering the high heterogeneity of components, communication mediums, and protocols across the infrastructure 208, a diverse range of contextual data may be extracted by the context extraction module 212. The contextual data may comprise different data types and formats. To efficiently use the contextual data 218 generated from heterogeneous resources, it may be desirable to standardized the contextual data.

The context modelling module 214 receives the raw contextual data 920 extracted by the context extraction component 212 and represents the contextual data 218 in a standardised format 216.

In operation 952, the context modeller 214 parses the raw contextual data 920 for each configuration item into a standardised format that encapsulates the capability status code and the actual raw output produced by the system.

In some embodiments, the standardised format of the contextual data comprises a hierarchical JavaScript Object Notation (JSON) structure. Advantageously, the low footprint of JSON structure may help to minimise the system overhead which is a critical point in large-scale systems.

To facilitate the modelling of contextual data from each component type, multiple scripts may be executed by the context modelling module 214. These scripts parse the JSON output emanating from the context extraction module 212, unify the diverse raw outputs of different configuration items within each attribute across various components, and ultimately craft a standardised hierarchical JSON output.

### Relevant Contextual Information Identifier

In operation 954, the context modeller provides the standardised contextual data 940 to the RCII module 224.

The RCII module is configured to find the relevant contextual data that should be checked (per each of the relevant security policies 252) from the standardised contextual data 940 extracted from infrastructure. The RCII module is configured to analysis the relevant contextual data to determine whether the infrastructure is compliant with the relevant security policies 252.

The RCII module 224 is configured to apply one or more methodologies to interpret the standardised configuration data 940 provided by the context modelling module, and map the contextual data to the relevant security policies 252.

There are two key challenges to mapping security policies to the contextual data. 1) The contextual data obtained from different entities in the system (e.g., devices, servers, protocols, etc) are highly heterogeneous in terms of their data representation formats, data types, and naming convention of their attributes. Moreover, the context extraction components provide full contextual data of the system, while some of these information may not be directly related to security concerns 2) policies defined in the security standards and guidelines are usually high-level and hence they do not provide detailed information regarding what configuration or attributes in each entity should be specifically checked.

In one embodiment, the RCII module comprises a machine learning model trained to 1) map high level security policies to contextual data obtained from the system 2) unify the attributes that are used to present same functionality in different entities (e.g., devices) via different naming conventions.

In one embodiment, the RCII module 224 applies a JSON agent to interpret the configuration data stored in JSON format. This method allows the RCII module to directly parse and understand the structure of the configuration data, making it easier to relate specific configurations to their relevant security policies.

In one embodiment, the RCII module 224 comprises a trained machine learning model configured to apply a classification task using NLP techniques to categorize the content of the configuration data. The model is trained to recognize the language patterns indicative of compliance or non-compliance with the security policies. By understanding the semantic content of the configuration data, the model makes informed decisions about the alignment of the configuration data with security requirements.

### Compliance Check and Visibility Pipeline

The CCV pipeline 220 is configured to perform compliance checks and provide coarse and granular visibility of the compliance of the infrastructure with one or more security policies, based on the user query 250 and obtained contextual data 216 from the CP pipeline 210.

The CCV pipeline is configured to receive input from each of the other two pipelines. In particular, the CCV pipeline receives one or more relevant security policies 252 from the QDI pipeline 230. Additionally, the CCV pipeline receives modelled contextual data 216 from the CP pipeline 210.

The CCV pipeline performs security compliance checking based on the security policy 252 and the modelled contextual data 216.

### Visibility and Compliance Check

The visibility and compliance check (VCC) module 260 is configured to determine whether the infrastructure 208 satisfies the relevant security policies 252 or not. To determine this, the visibility and compliance check module 260 receives the relevant security policies and modelled contextual data 216 of the components within the infrastructure. The VCC module 260 determines whether the contextual data indicates that the security policy has been satisfied or not by value of the configuration item.

In some embodiments, the VCC module 260 comprises a trained machine learning model which is trained to determine, based on the contextual data of the components of the network infrastructure and based on one or more security policies, whether the network infrastructure is compliant with the one or more security polices.

In some embodiments, the trained machine learning model of the VCC module is the same trained machine learning model as the first machine learning model 406. In other embodiments, the, the trained machine learning model of the VCC module comprises a second trained machine learning model. The second trained machine learning model may comprise a neural network, a deep learning model or a classifier.

In some embodiments, the trained machine learning model comprises a classifier (such as a random forest classifier), which is configured to classify the contextual data as indicating compliance with the one or more security policies, or not indicating compliance with the one or more security policies.

The VCC module 260 is configured to determine the configuration items that are relevant configuration items with regard to a security policy. In some embodiments, the VCC module the configuration items that are relevant configuration items with regard to a security policy by mapping the security policy 252, to the segment of text 670 from the security standard, to the tagged security attributes 680 to the configuration items 608.

Subsequently, the VCC module 260 is configured to determine, based on the values of those relevant configuration items, an indication of whether the component complies with the security policy.

### Indication of Compliance

In response to the security policy not being complied with, the visibility and compliance check module 260 provides detailed information on the underlying issues. On the other hand, if the policy is satisfied, it furnishes the user with a positive response.

The VCC module outputs an indication of whether the network infrastructure 208 satisfies the security policy 252. This indication may be referred to as an indication of compliance 280.

### The Indication of Compliance May Comprise:

‘Satisfied’, meaning that the components have all the required capabilities to satisfy the security policy;
‘Caution’, meaning that the components have some of required capabilities to satisfy the security policy, however some of the required capabilities are not available.
‘Not satisfied’, meaning that the components do not have required capabilities to satisfy the security policy.

An indication of compliance may be provided for the network infrastructure 208 as a whole. In some embodiments, an indication of compliance may be provided for each component in the network infrastructure.

In some embodiments, the indication of compliance may comprise an indication of rectification actions. The rectification actions comprises actions which may be taken to ensure the network infrastructure complies with the security standard. The rectification actions may comprise: the removal of components from the network infrastructure; the addition of additional components to the network infrastructure; a configuration update to be applied to a component of the network infrastructure; or any combination thereof.

In some embodiments, in response to the indication of compliance indicating that the network infrastructure does not satisfy the security policy of the security standard, the application 180 is configured to determine a configuration update for a component of the network infrastructure. The configuration update is configured to adjust at least one configuration item of the component, so that the component complies with the security policy.

In some embodiments, the application 180 is configured to apply the configuration update to the one or more components of the network infrastructure that do not comply with the security policy.

### Infrastructure Topology Perception

The CCV pipeline may further comprise an infrastructure topology perception (ITP) module 222. The ITP module is configured to construct an infrastructure topology.

In some embodiments, the ITP module is configured to construct the infrastructure topology by determining the connections between all components within the network infrastructure 208. In some embodiments, the infrastructure topology comprises a topology graph. In some embodiments, the topology graph is structured as a graph model, or graph database. In some embodiments, the ITP module 222 is configured to dynamically adjust the topology graph of the network infrastructure in response to the addition or removal of components from the network infrastructure.

The ITP module may obtain topology information from routers of the network infrastructure. Routers serve as the cornerstone for constructing the topology graph of devices within the environment. For each router of the infrastructure, the ITP module 222 is configured instruct the router, via an API of the router, to execute a script to identify all components accessible to the router. Each router determines a local network topology, which indicates the components accessible to the router. The local network topology may also indicate connections between components that are each accessible to the router.

Each router provides its local network topology to the infrastructure topology perception module 222. The routers may communicate the local network topologies to the infrastructure topology perception module asynchronously. The infrastructure topology perception module combines these local network topologies from the plurality of routers to create a combined topology graph of the network infrastructure 208.

In some embodiments, the ITP module is configured to provide information 254 regarding the infrastructure topology to the Query Interpreter module 232, to aid in the interpretation of user queries. The QI module may apply topology information to determine the components that are in the network infrastructure and the components that are in communication with a component of interest identified in the user query. Accordingly, the topology information may identify a subset of the components, communication methods, protocols when a user query pertains to a particular subset of the infrastructure.

In some embodiments, the ITP module is configured to provide information 228 regarding the infrastructure topology to the RCII module 224. In some embodiments, the RCII module is configured to apply the infrastructure topology information when mapping the attributes to the configuration items per attribute per component, in operation 608.

Process flow diagrams provided herein (including FIGS. 5, 6 & 9) illustrate operations performed in an illustrative method, and may not recite the complete process or all operations of the method. The depicted and described operations need not necessarily all be performed, and in some cases may be performed simultaneously or in a different order than the order shown.

To avoid obscuring the inventive subject matter with unnecessary detail, various functional components (e.g., modules, devices, databases, etc.) that are not germane to conveying an understanding of the inventive subject matter have been omitted from the figures. However, a skilled artisan will readily recognize that various additional functional components may be supported by the system to facilitate additional functionality that is not specifically described herein. Furthermore, the various functional components depicted in the figures may reside on a single computing device or may be distributed across several computing devices in various arrangements such as those used in cloud-based architectures.

It will be appreciated by persons skilled in the art that numerous variations and/or modifications may be made to the above-described embodiments, without departing from the broad general scope of the present disclosure. Furthermore, it will be appreciated by persons skilled in the art that embodiments disclosed herein can be combined with one or more other embodiment disclosed herein, without departing from the broad general scope of the present disclosure. The present embodiments are, therefore, to be considered in all respects as illustrative and not restrictive.

It will be appreciated by persons skilled in the art that any suitable distribution of functionality between different functional units may be used without detracting from the invention. For example, functionality illustrated to be performed by separate computing devices may be performed by the same computing device. Likewise, functionality illustrated to be performed by a single computing device may be distributed amongst several computing devices. Hence, references to specific functional units are only to be seen as references to suitable means for providing the described functionality, rather than indicative of a strict logical or physical structure or organization.

It will be appreciated by persons skilled in the art that, for processes and methods disclosed herein, the operations performed in the processes and methods may be implemented in differing order. Furthermore, the outlined steps and operations are only provided as examples, and some of the steps and operations can be optional, combined into fewer steps and operations, or expanded into additional steps and operations without detracting from the essence of the disclosed embodiments.

References herein to software or executable instructions are to be understood as referring to executable instructions stored in volatile or non-volatile memory. The memory may comprise a non-transitory machine-readable storage medium. The memory can include any data storage device that can store data which can thereafter be read by a processor. Examples of memory include read-only memory (ROM), random-access memory (RAM), magnetic tape, optical data storage device, flash storage devices, or any other suitable storage devices.

Throughout this specification the word ‘comprise’, or variations such as ‘comprises’ or ‘comprising’, will be understood to imply the inclusion of a stated element, integer or step, or group of elements, integers or steps, but not the exclusion of any other element, integer or step, or group of elements, integers or steps.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Moreover, in the following claims, the terms “first,” “second,” and “third,” etc. are used merely as labels, and are not intended to impose numerical requirements on their objects.

What is claimed is:

1. A computer-implemented method for determining the compliance of a network infrastructure with a security policy, the network infrastructure comprising a plurality of components, the method comprising:
extracting, by applying a first trained machine learning model to a security standard, at least one security policy of the security standard;
obtaining, from each component of the plurality of components of the network infrastructure, contextual data defining the security configurations and security capabilities of the component; and
processing the contextual data and the security policy of the security standard, by a second trained machine learning model, the second trained machine learning model configured to output an indication of whether the network infrastructure satisfies the security policy of the security standard.

2. The method of claim 1, wherein processing the contextual data and the security policy of the security standard comprises:
mapping, by the second trained machine learning model, the security policy to the security configurations defined by the contextual data.

3. The method of claim 1, wherein processing the contextual data and the security policy of the security standard comprises:
determining, by processing the security capabilities, whether the network infrastructure is capable of satisfying the security policy; and
in response to determining that the network infrastructure is capable of satisfying the security policy, determining, by processing the security settings, whether the network infrastructure satisfies the security policy of the security standard.

4. The method of claim 1, wherein obtaining the contextual data comprises:
issuing at least one command to at least one component of the network infrastructure; and
receiving, from the at least one component of the network infrastructure, the contextual data.

5. The method of claim 1, wherein obtaining the contextual data comprises applying a third trained machine learning model to raw contextual data to determine standardised contextual data.

6. The method of claim 5, wherein the standardised contextual data is formatted as a hierarchical JSON structure.

7. The method of claim 1, wherein the contextual data comprises one or more of:
infrastructure topology; security settings; security capability; supported encryption algorithm;
key length; protocol version; firmware version; communication protocol; key exchange protocol; and hash function.

8. The method of claim 1, wherein obtaining contextual data comprises determining an infrastructure topology of the network infrastructure.

9. The method of claim 8, wherein determining an infrastructure topology comprises:
obtaining, from routers in the network infrastructure, local graph topologies and combining the local graph topologies to determine a topology graph of the network infrastructure.

10. The method of claim 1, wherein extracting at least one security policy of the security standard comprises segmenting the security standard into a plurality of segments.

11. The method of claim 1, wherein extracting at least one security policy of the security standard comprises applying a trained embedding transformer model to generate a security embeddings of a segment of the plurality of segments.

12. The method of claim 11, wherein the trained embedding transformer model is trained on security standards.

13. The method of claim 1, further comprising:
receiving a security query from a user of the network infrastructure; and
selecting, based on the security query, the at least one security policy.

14. The method of claim 13, wherein selecting, based on the security query, the at least one security policy comprises applying a large language model to map the security query to the at least one security policy.

15. The method of claim 13, wherein selecting, based on the security query, the at least one security policy comprises:
applying a trained embedding transformer model to generate a query embedding of the security query; and
selecting, based on the query embedding, the at least one security policy.

16. The method of claim 15, wherein selecting, based on the query embedding, the at least one security policy comprises determining a semantic similarity between the query embedding and the security embedding.

17. The method of claim 16, wherein determining a semantic similarity between the query embedding and the security embedding comprises determining a similarity threshold.

18. The method of claim 1, further comprising, in response to the indication of whether the network infrastructure satisfies the security policy of the security standard indicating that the network infrastructure does not satisfy the security policy of the security standard:
determining a configuration update for at least one component of the plurality of components; and
providing the configuration update to the at least one component of the plurality of components.

19. A non-transitory machine-readable storage medium storing instructions which, when executed by one or more processors, individually or in combination, cause the one or more processors to perform the method of claim 1.

20. A system comprising:
one or more processors; and
memory comprising computer executable instructions, which when executed by the one or more processors, individually or in combination, cause the system to perform the method of claim 1.
